(19) United States
(12) Patent Application Publication
(10) Pub. No.: US 2007/0255605 A1
(43) Pub. Date: Nov. 1, 2007

(54) Multi-period financial simulator of a manufacturing operation

(76) Inventor: David Meade, Muskegon, MI (US)

Correspondence Address: FLYNN THIEL BOUTELL & TANIS, P.C., 2026 RAMBLING ROAD, KALAMAZOO, MI, 49008-1631, US

(21) Appl. No.: 11/415,357

(22) Filed: May 1, 2006

(51) Int. Cl. G06F 19/00

(52) U.S. Cl. 705/7; 700/108

(57) ABSTRACT

A system and method for evaluating a manufacturing process or operational strategy of a business. The proposed manufacturing process or operational strategy is programmed into a multi-period financial simulator that iteratively models or simulates the proposed process or strategy for multiple periods of time. After one or more of the multiple periods of time, the multi-period financial simulator generates one or more types of financial data indicating how the proposed manufacturing process or operational strategy would affect the business.

### FIELD OF THE INVENTION

The present invention relates to a system and method for simulating a manufacturing process and, more specifically, to a system and method for determining how a specific manufacturing process or operational strategy will effect the financial statement of the business over a span of multiple reporting periods.

### BACKGROUND OF THE INVENTION

The purpose of any manufacturing business is to purchase raw materials and/or components and subsequently convert these materials and components into a product of greater value that can be sold for a higher price. It is in this manner that profit is made.

However, in order to be successful, a manufacturing business requires considerable planning. A manufacturer needs to control the types and quantities of materials they are purchasing, plan which products are to be produced as well as determine the quantities needed, and ensure that they are able to meet both current and future customer demand. Improper planning in any of these areas can readily lead to lost sales and decreased profits.

For instance, the purchasing of an insufficient quantity of an item used in manufacturing, or the wrong item, can result in the manufacturer being unable to supply enough of their product to a customer by an agreed upon date. To prevent the above from occurring, many companies will purchase excessive quantities of raw materials or items needed for the manufacturing process. However, this also results in money being wasted, as an excess quantity of materials and items tie up cash while they remain as stock. Similar to stock levels, the timing of a production run is also important. For example, beginning production of an order at the wrong time can lead to a customer deadline being missed, and ultimately, a loss in sales.

To facilitate the planning necessary for a successful manufacturing business, many manufacturers utilize a business planning technique known as Material Requirements Planning (MRP). The typical MRP system is a computer-implemented scheduling procedure for one or more production processes. Generally speaking, MRP systems automate the analysis of certain aspects of a manufacturer's operations in order to provide answers to three specific questions, including what items (i.e., raw materials and finished goods) are required, how many are required, and when are they required by.

FIG. 1 depicts a typical Material Requirements Planning (MRP) system 10, which works on certain input data 12 provided to the system 10 in order to generate some specific output data 14. Data input into the MRP system 10 includes a production schedule 12A, which is a combination of all the known and expected demand over a defined period of time for the products being created. The production schedule provides information on the products being created, how much of the products are required at a time, and when a quantity of products is required to meet demand. Also input into the MRP system 10 is data concerning inventory status 12B, including records of net materials already in stock and available for use, as well as materials on order from suppliers. The MRP system 10 also requires a bill of materials 12C, which provides detailed information on the raw materials, components and subassemblies required to make each product. Lastly, the MRP system must be provided with certain planning data 12D, such as, for example, batch size or maximum amount of a material or item that can be processed at any one time.

The MRP system 10 analyzes the input data and generally provides recommendations on when a batch of product should be produced in order to meet an expected demand, as well as the amount of raw materials or items required for the production of the product. More specifically, the MRP system 10 outputs two types of data. The first output 14A is a recommended production schedule that lays out a schedule of the required minimum start and completion dates for production of a product, along with needed quantities of materials provided in the bill of materials. The second output 14B is a recommended purchasing schedule that lays out the dates that raw materials and components should be ordered as well as received.

Accordingly, the MRP system 10 is an automated set of techniques that analyzes production schedules, bill of materials, and inventory data in order to calculate stock or inventory requirements. The typical system also generates recommendations on when new materials should be purchased so as to maintain an inventory level necessary for the manufacturing of a product.

As such, Material Requirements Planning (MRP) systems are designed to facilitate the day-to-day operation of a manufacturing plant by generating recommended schedules on when production of a product should occur as well as when new inventory of materials and parts should be acquired. These recommended schedules are determined in response to the desired outcome of the manufacturing process as previously indicated to the MRP system (i.e., one desired outcome being the need to manufacture 200 widgets now, and maintain sufficient stock levels so that an additional 200 widgets can be manufactured two days from now). Thus, typical MRP systems focus on the manufacturing schedules necessary to meet a specific production goal, they do not focus on the actual manufacturing process itself, nor do they provide any analysis on how the manufacturing process my be potentially improved.

Similar to MRP systems, Discrete Event Simulators (DES) are a second type of computerized tool frequently utilized in a manufacturing environment. However, unlike MRP systems, Discrete Event Simulators analyze the actual manufacturing process, allowing a user to assess how the efficiency of a particular manufacturing process might be improved.

Specifically, a Discrete Event Simulator (DES) models a manufacturing process and simulates the behavior of the process as time progresses. The DES system evaluates the manufacturing process as consisting of discrete units of traffic that move or flow through a series of steps representing the various stages of an assembly line.

To further illustrate the above point, see FIG. 2, which depicts a process for manufacturing a specific product 24, such as, for example, a widget. One or more initial components or raw materials 20 are first introduced at a first stage 22A of an assembly line. Once initial processing is complete, the raw material 20 is passed through the remaining stages 22B-22F of the assembly line. Certain stages 22A, 22D, 22F may simply act upon or process the existing components of the unfinished widget, while other stages 22B, 22C, 22E supplement the unfinished widget with additional components 23, 25, 27. Ultimately the widget passes through the final stage 22F of the assembly line and becomes a finished product 24 that is ready to be sold.

To accurately model the widget manufacturing process, the DES system can be programmed to emulate the behavior of the various stages 22A-22F of the assembly line. This subsequently provides manufacturing personal with the ability to evaluate how the efficiency of the assembly line is affected in response to either a proposed or actual change to the manufacturing process.

To further illustrate the above point, consider another example wherein a DES system is configured to model the assembly line of FIG. 2. An engineer or other manufacturer personal subsequently alters the virtual behavior of stage 22D of the assembly line, programming the DES system to act as if the components making up stage 22D have been replaced by a newer, more efficient device. The simulated assembly line represented in the DES system is then allowed to run through one pass or iteration of the manufacturing process, thereby allowing the performance of the assembly line as well as any potential problems to hopefully be ascertained.

FIG. 3 illustrates a traditional Discrete Event Simulator (DES) system 30. As depicted in FIG. 3, a traditional DES system 30 typically requires the input of three types of data. The first type of input data includes various operation parameters 32A specific for the manufacturing process/assembly line being evaluated. Parameters include, for example, the number of stations or machines in the assembly line, the product routing, and the available manpower, as well as various operational characteristics such as set-up data, cycle times, etc. The second type of input data includes the duration of the product run 32B. This duration value can be represented, for example, as a number of hours an assembly line is run, or alternatively, the number of units produced. The last type of input data provided to the DES system 30 is the production schedule 32C, which as previously discussed, represents both the known and expected demand for a product over a defined period of time. The production schedule provides information on the products being created, how much of the products are required at a time, and when a quantity of products is required to meet demand.

The DES system 30 subsequently analyzes the three types of input data 32A-32C described above and outputs two pieces of data that generally represents the efficiency of the manufacturing process. The first data output by the DES system 30 comprises one or more values representing a measured utilization or efficiency 34A of the machines and associated workers that make up the assembly line. From this data the manufacturer can determine, for example, the number of man hours that would be consumed by the simulated manufacturing process if it was actually implemented in real life. The data also provides a measurement of the percentage of time that a worker and their associated workstation were active verses idle. The second piece of data output by the DES system 30 comprises the estimated number of products that would be produced if the simulated manufacturing process were implemented in real life.

Accordingly, Discrete Event Simulators (DES) provide manufacturing personal with the ability to simulate a manufacturing process, and then determine how certain changes to one or more steps of the process affect the manufacturing efficiency for a product as indicated by resource utilization and number of products produced. Although useful, traditional DES systems are typically restricted in their functionality, being limited to providing information concerning manufacturing capacity, and process effectiveness comparisons for a single iteration of a manufacturing cycle, i.e., shift, day, week, month, number of hours, etc. Consequently, DES systems are typically considered useful primarily just for evaluating alternative approaches to process improvement.

Similar to other existing computer-based manufacturing aids, DES systems provide no insight or assistance on how proposed or actual changes in a manufacturing process effect the financial statements of the manufacturing business. Similarly, DES system are typically configured to only operate for a single manufacturing cycle, whereby the assembly line under investigation is activated for only a single run once the necessary input data is received by the DES system. Consequently, even if DES systems were capable of providing information concerning how changes in the manufacturing process impact the financial statements of the business, the resultant information would still be of questionable relevance due the DES system's lack of conducting repeated test cycles that allow for generated data to be fed back into the process and further refined.

### SUMMARY OF THE INVENTION

A system and method for evaluating a manufacturing process or operational strategy of a business. The proposed manufacturing process or operational strategy is programmed into a multi-period financial simulator that iteratively models or simulates the proposed process or strategy for multiple periods of time. After one or more of the multiple periods of time, the multi-period financial simulator generates one or more types of financial data indicating how the proposed manufacturing process or operational strategy would affect the business.

### BRIEF DESCRIPTION OF THE DRAWINGS

One or more embodiments of the present invention are illustrated by way of example and should not be construed as being limited to the specific embodiments depicted in the accompanying drawings, in which like references indicate similar elements and in which:

FIG. 1 illustrates a traditional Material Requirements Planning (MRP) system.

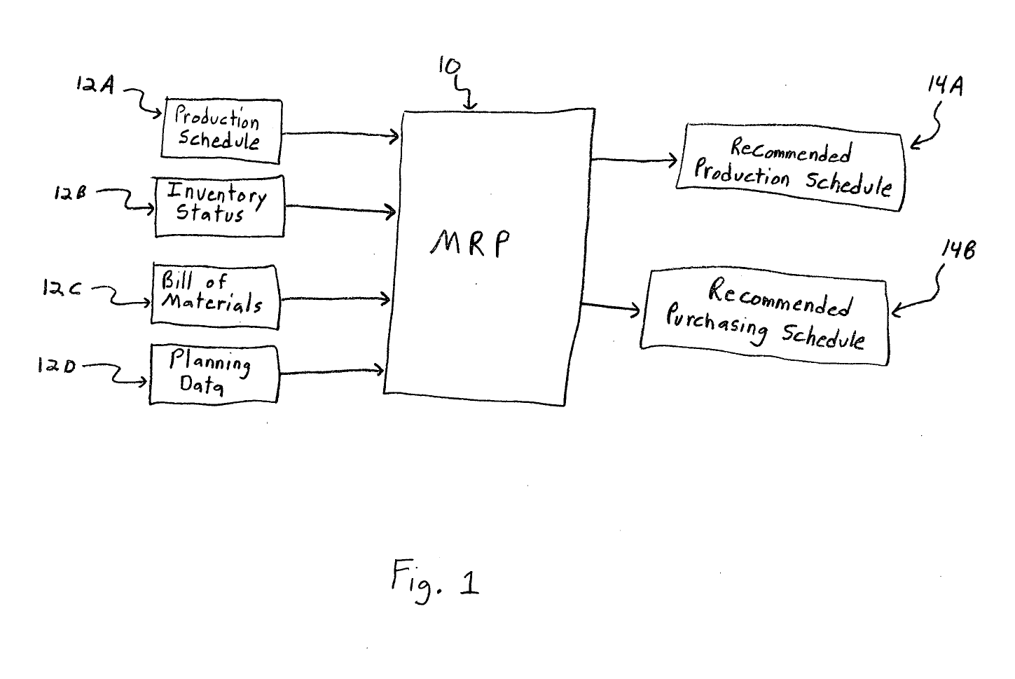

FIG. 2 illustrates a typical manufacturing process whereby raw materials or components are fed into and processed by an assembly line before ultimately becoming a finished product.

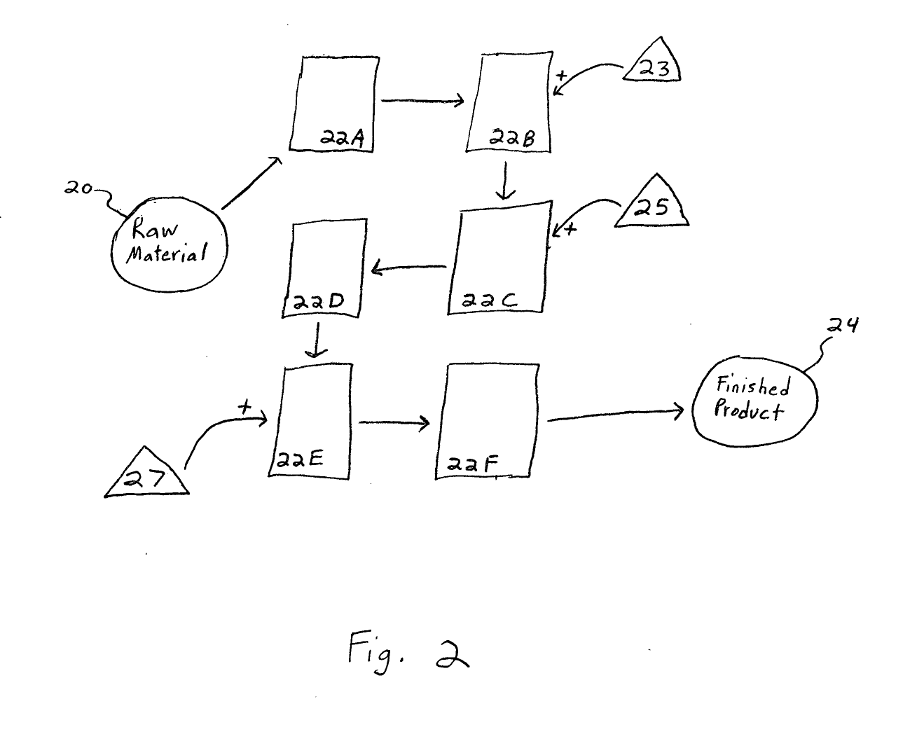

FIG. 3 illustrates a traditional Discrete Event Simulation system for evaluating alternative manufacturing processes on the basis of production capacity and process effectiveness.

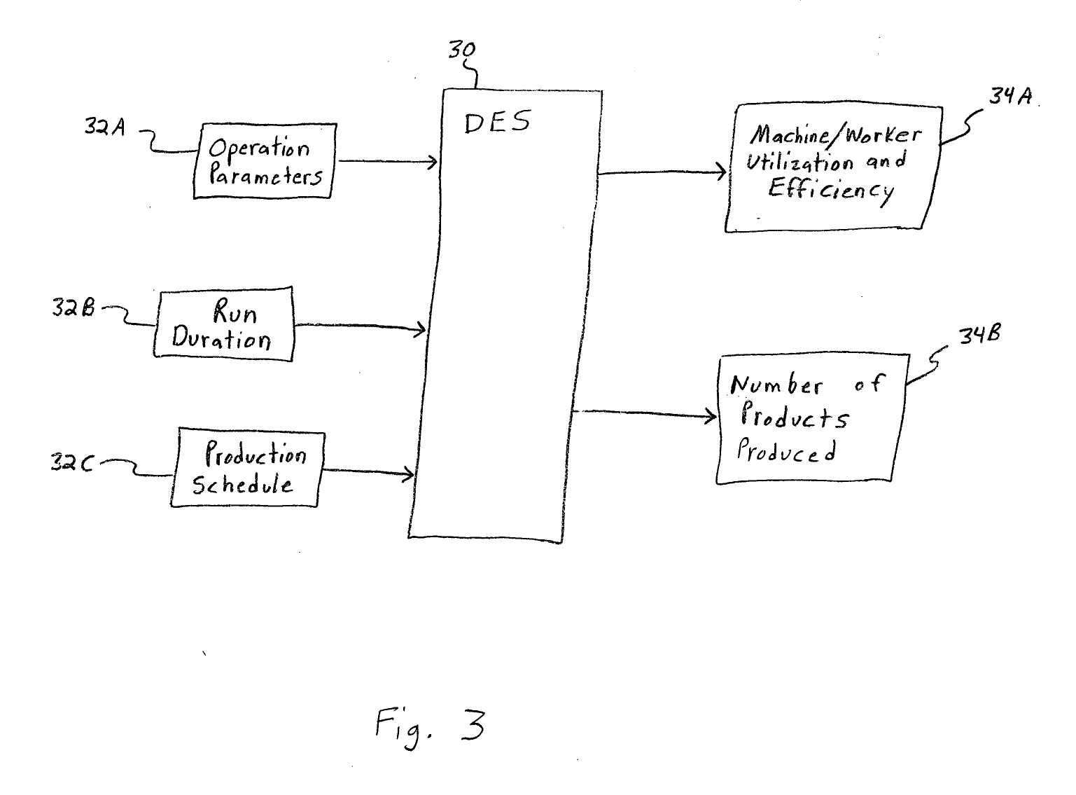

FIG. 4 illustrates a multi-period financial simulator for a manufacturing operation according to a first embodiment.

FIG. 5 depicts a chart illustrating some of the more common factors found in a manufacturing environment that determine the gross and net profits of the business.

FIG. 6 illustrates a multi-period financial simulator for a manufacturing operation according to a second embodiment.

FIG. 7 depicts an applied example of a multi-period financial simulator indicating how changes in monthly reported gross profit can result from inventory build-up and ramp down.

### DETAILED DESCRIPTION

As previously discussed, the computer-aided tools traditionally utilized in the manufacturing industry are frequently limited in their functionality. These existing tools, such as Material Requirement Planning (MRP) systems and Discrete Event Simulators (DES), are typically configured to provide very specific and limited guidance with respect to either the ordering of parts and materials, or a predicted change in manufacturing efficiency in terms of resource utilization and production. Neither of these two types of traditional tools provides the ability to simulate a plurality of manufacturing periods and subsequently analyze how a change in the manufacturing process effects the financial statements of the business.

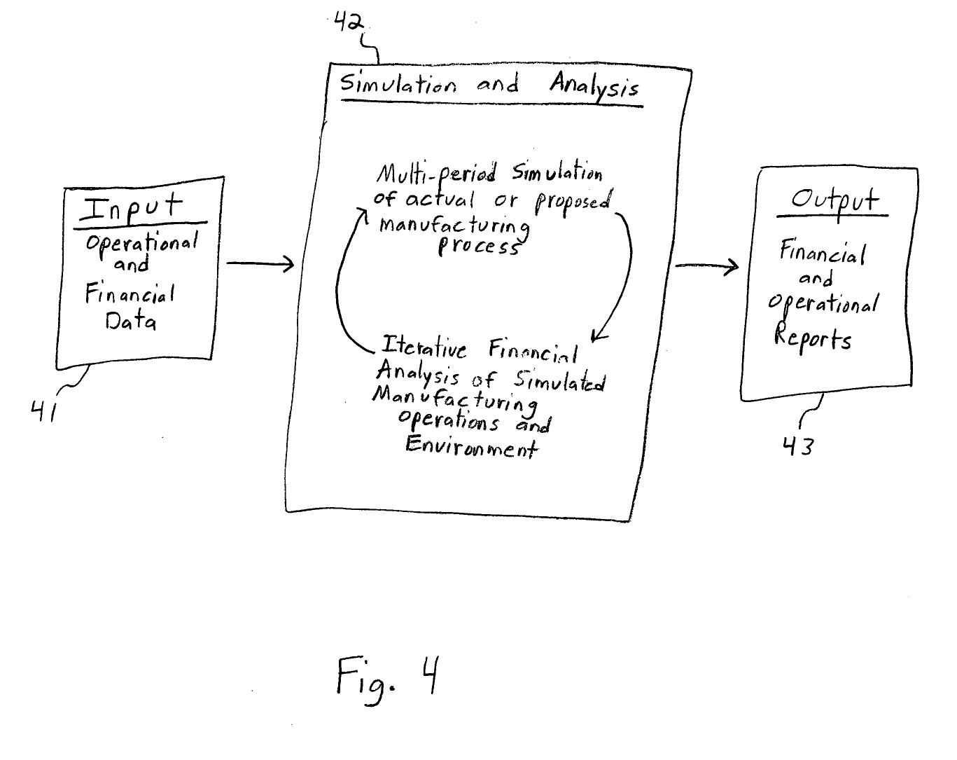

To address the deficiencies noted above, the Applicant has developed and disclosed within the present application a system and method for conducting multi-period financial simulations of a manufacturing operation. FIG. 4 depicts one such multi-period financial simulator according to a first embodiment of the invention.

As depicted in FIG. 4, the simulator system 42 is first programmed with various operational and financial data 41 related to the manufacturing process. The system 42 then proceeds to simulate the programmed manufacturing process, which represents either an actual process being implemented by the business, or alternatively a proposed manufacturing process being evaluated for possible implementation. While the manufacturing process is being simulated, the system 42 also carries out repeated or iterative financial analysis of the manufacturing operations and environment being simulated. Upon conclusion of the multi-period simulation, the system 42 outputs various financial and operational reports 43 indicating how the financial statements (e.g., the gross and net profit) of the business would be effected by actual implementation of the simulated manufacturing process.

To further understand the reasoning and underlying principles behind the present invention, it should be realized that the income statement or profits of a manufacturing business are effected by numerous factors. Some factors have an obvious effect on a business'0 income statement, while other factors effect the income statement in less obvious ways. Regardless, the present invention simplifies what otherwise could be a difficult financial analysis by establishing a process whereby a user, such as a financial planner of a business, can readily determine how one or more proposed changes to a manufacturing process effects the financials (i.e., gross and net profits) of the business. In general, the present invention accomplishes this by requiring a user to first input select data concerning the business and its operations. The system then employs a multi-period logic to determine how proposed changes to a manufacturing process would affect various other factors of the business, and subsequently, how these modified factors would effect the financial statement of the business.

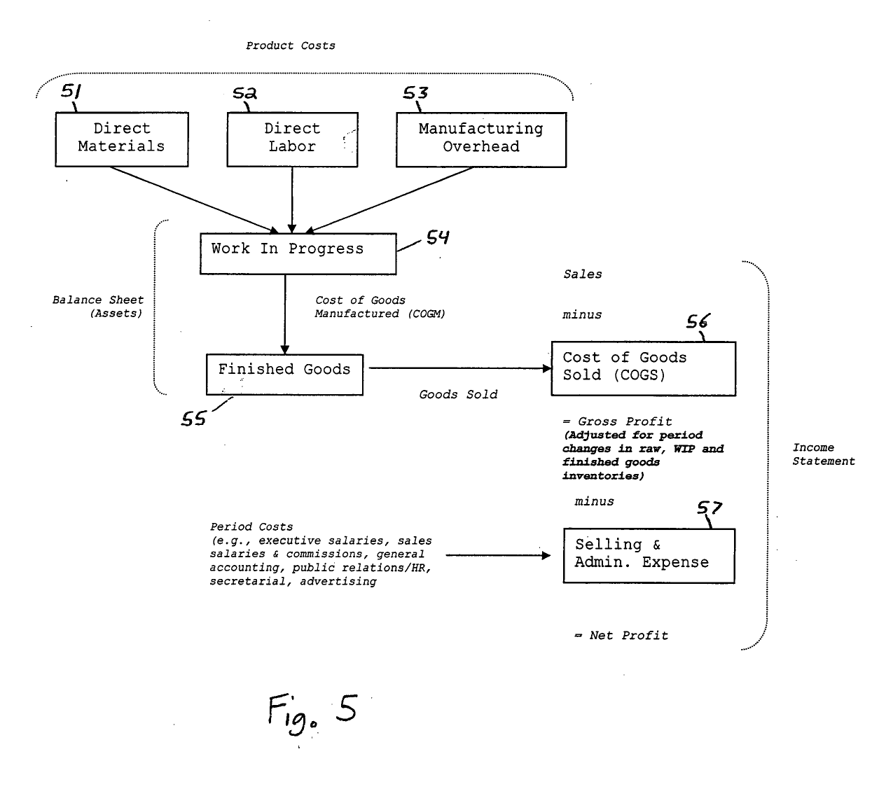

To further illustrate the above point, consider the chart of FIG. 5, which illustrates some of the more common factors found in a manufacturing environment that determine the gross and net profits of the business. As depicted in FIG. 5, the direct costs of materials 51, direct costs of labor 52, and manufacturing overhead costs 53 all contribute to the actual cost of the goods being manufactured, which includes both the products in the process of being made 54, as well as the products that have completed manufacturing and are now finished goods 55. Product sales minus the cost of goods sold 56 subsequently yields the gross profit of the business, and upon subtraction of the selling and administrative expenses 57, yields the net profit of the business.

However, to complicate matters, the gross profit must be adjusted to account for the various assets held by the business, which include the raw materials held in inventory as well as the inventories of the work in progress and finished goods. Similarly, period adjustments must also be made to the selling and administrative expenses 57 before an accurate determination of net profit can be made.

Every factor identified above with respect to FIG. 5 can be directly or indirectly affected by even the slightest change in the manufacturing process. For example, one business may be considering the implementation of a lean manufacturing model in order to reduce the inventory levels that the business normally maintains. Such a proposed change would likely influence or change many factors, including not only the inventory levels, and thus the assets of the business, but also various other factors such as labor costs and overhead. The present invention simplifies the above process by employing multi-period logic to accurately track and determine how a specific change, such as decreased inventory levels, will effect every other aspect of the business, and in turn, their impact on the financial statement.

Accordingly, the present invention allows a business to quickly and easily test a proposed change to the manufacturing process (i.e., a modification to the assembly line) and determine how that proposed change would financially effect the business. Thus, for example, by implementing the multi-period financial simulator of the present invention, a manufacturer can readily ascertain what would happen to the gross and net profits of the business over the next X number of months if:
There is an increase/decrease in the number of labor hours required to produce product Y (i.e., due to changes in personal or equipment)?
There is an increase/decrease in the amount of finished product Y being produced over a specified period of time (i.e., the addition of a second assembly line)?
There is a decrease in the minimum level of inventory that must be maintained for raw materials and components (i.e., implementation of a lean manufacturing program)?
There is an increase in the amount of finished goods being held in inventory (i.e., due to increased production and/or decreased sales)?
There is an increase/decrease in the manufacturing overhead costs (i.e., building costs, utilities, etc.)?
There is an increase in the cost of labor?
There is an increase in the cost of raw materials and components?

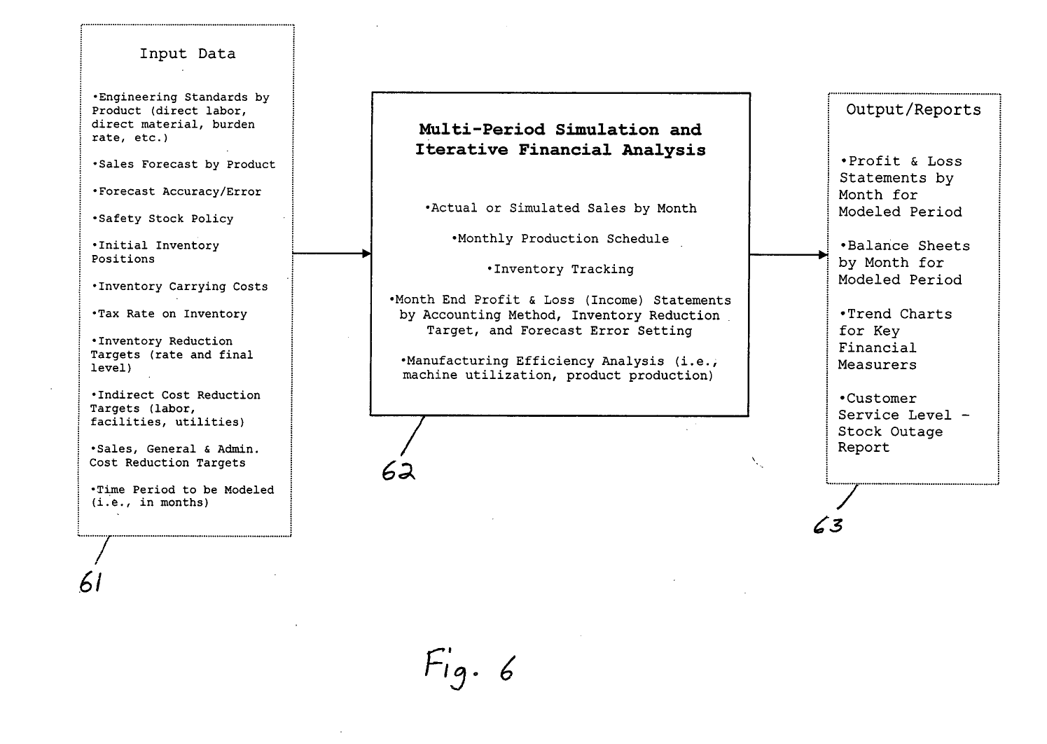

FIG. 6 illustrates a multi-period financial simulator for a manufacturing operation in accordance with another embodiment of the present invention. As illustrated in FIG. 6, the computer-based simulator system 62 is first programmed with various input data 61 describing select factors or operating parameters of the business. Depending on the business, the input data can include, for example, various engineering standards by product, sales forecast by product, the forecast accuracy, the safety stock policy, the initial inventory levels, the inventory carrying costs, the tax rate on the inventory, possible inventory reduction targets, various indirect cost reduction targets, sales, general and administrative cost reduction targets, and the desired time period that should be encompassed by the model or simulation being evaluated.

Once the input data 61 is received, the computerized financial simulator system 62 begins to analyze the data in accordance with its programmed, multi-period logic to determine how the proposed changes would effect the financial statement of the business. Specifically, the system 62 will simulate the proposed process for a given manufacturing period (i.e., one month) and subsequently process all of the data in accordance with its programmed logic to determine the financial effects of the proposed process. During this time, the system logic will not only conduct manufacturing efficiency analysis, but also carry out inventory tracking, develop a monthly production schedule, and determine monthly sales and month end profits and losses.

The system 62 will then repeat the analysis, running the simulation and processing the data for a second, subsequent manufacturing period (i.e., a second month). The system 62 will continue to do iterative analysis of the proposed changes for subsequent time periods until the end of the specified simulation time frame is reached.

The system 62 then generates or outputs various reports 63 concerning the operations and finances of the business. These reports 63 can include, for example, profit and loss statements by month, balance sheets by month, trend charts for key financial measurers, and customer service levels and stock outages.

To demonstrate the advantageous uses of the multi-period financial simulator as described above, consider an example where a manufacturing business seeks to determine what the financial results would be in response to implementing a lean manufacturing program that emphasizes minimizing the amount of all resources (including time) used in the manufacturing process. The simulator is provided with various input data describing select characteristics or operating parameters of the proposed lean manufacturing program. The simulator then attempts to model a real-world manufacturing operation where a schedule is established based on a forecast and current inventory levels. The simulated plant attempts to satisfy the schedule, at times falling short. At the conclusion of the month, profit and loss statements are produced based on the results of the period including actual sales. The process then repeats for each subsequent month for a total of 12 months.

The above simulation is run three times, with a different inventory reduction scenario being evaluated each time. The first scenario is a baseline, and represents no reduction in inventory over the twelve month simulated period. The second scenario assumes a “moderate” 50% reduction in on hand inventory over the twelve month period. The third scenario assumes an “aggressive” 50% reduction in inventory in the first six months, and then no further reductions for the remainder of the year.

Analysis of the three simulations indicate some interesting results. A no reduction in inventory policy produced the highest mean gross net profit for the first six months of the twelve month period evaluated. The aggressive reduction policy produced the lowest values for reported gross net profit during the same period. Starting with month seven and continuing through month twelve, the mean values for the no reduction policy and aggressive reduction policy were not significantly different, while the moderate reduction policy produced lower profit values for the same period. For further details concerning this example and its analysis, see “Multi-Month Simulation of a Lean Manufacturing Implementation Program” by David J. Meade and Sameer Kumar, herein incorporated by reference.

According to a second example, the multi-period financial simulator of the present invention can be used to assess the impact that a manufacturing plant consolidation would have on the monthly financial performance of the business. In this example, simulation data could assist the manufacturer in identifying a target level for increased finished goods inventories necessary to allow the disruptions in manufacturing when equipment is taken off-line to be moved.

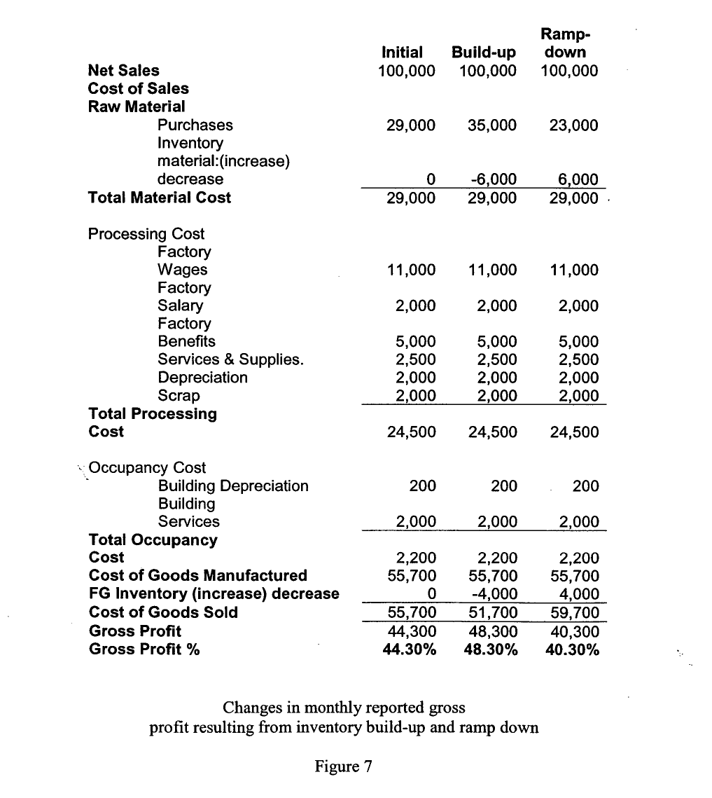

Simulation results indicate that the temporary increases in inventory will have the effect of increasing the reported gross and net profits of the business while more products are being produced than sold. However, the opposite will occur when the products are then consumed, returning the inventory levels back to where they were before plant consolidation. See FIG. 7, which depicts how changes in monthly reported gross profit can result from inventory build-up and ramp down. In this specific example, FIG. 7 clearly identifies the impact to the income statement resulting from only one project factor—inventory.

Note that a multi-period model would allow the modeling of a ramp-up in capacity as equipment is coming back on-line in the new location and the learning curve effects are being experienced. This combined with the ability to simulate the effects of forecast inaccuracies would allow a manufacturer to not only identify how much inventory to build-up ahead of the change, but also what products to build-up, leading to better predictions resulting in a reduction in stock-outs, or missed shipments, during the project implementation.

According to a third example, a manufacturer is supplementing their business through the addition of new capital equipment. The replacement of existing equipment or capacity expansion through the addition of new equipment requires production planning changes to accommodate the project. As in the previous examples, the present invention can be utilized to quickly and easily determine how the addition of new capital equipment would effect the short-term financial results, which may be opposite of what is expected depending on the potential disruption to short-term capacity. As in the second example, an inventory build-up may be required in anticipation of the affects of the learning curve with the new equipment. In this case, the same considerations exist as were discussed in the prior example. Again, multi-period simulation by the present invention would aid the planning of this project through the prediction of the impact to on-hand inventories as well as on financial statements.

In the embodiments disclosed above, the multi-period financial simulator is a stand-alone computer system comprising at least a processor and memory for the storage and enablement of the multi-period logic and running of simulations, along with one or more inputs for the receipt of input data required by the simulator. The simulator system may further include a user interface, such as a keyboard, to facilitate the entry of data into the system.

As previously indicated, the multi-period financial simulator as discussed above provides its own unique functionality that allows it to evaluate the effects of a manufacturing process on the financial statement, in addition to the same functionality offered by traditional discrete event simulator (DES) systems. Accordingly, the financial simulator can operate independent of, as well as readily replace, a traditional DES system. However, according to an alternative embodiment, the multi-period financial simulator could be configured to work in conjunction with a traditional DES system. In such a system, the financial simulator would have to be configured to receive the limited data generated by the DES system. For example, the financial simulator could be networked with the DES system so as to directly receive the data, or alternatively, simply receive the DES data indirectly through manual intervention by a user.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method of evaluating a manufacturing process, comprising the steps of:
selecting a proposed manufacturing process for evaluation;
inputting select operational parameters concerning the selected manufacturing process into a manufacturing process simulator;
inputting select financial data relating to the selected manufacturing process into the manufacturing process simulator;
running the manufacturing process simulator so as to simulate the selected manufacturing process for a first specified period of time;
generating operational data concerning a capacity and effectiveness of the selected manufacturing process over the first specified period of time;
generating financial data relating to the selected manufacturing process over the first specified period of time;
inputting into the manufacturing process simulator select operational and financial data previously generated during the first specified period of time;
running the manufacturing process simulator for a second, subsequent period of time so as to simulate the selected manufacturing process;
generating operational data concerning the capacity and effectiveness of the selected manufacturing process over the second specified period of time; and
generating financial data relating to the selected manufacturing process over the second specified period of time.

2. The method according to claim 1, further comprising the step of generating a financial statement comprising at least one of an income statement and a balance sheet.

3. The method according to claim 1, wherein at least one of the operational data and financial data generated includes one or more of product sales per specified period of time, manufacturing production schedule per specified period of time, inventory tracking data, profit and loss statement by accounting method, inventory reduction target data and forecast error setting data.

4. The method according to claim 1, wherein the financial data input into the manufacturing process simulator comprises at least one of sales forecast data, forecast accuracy data, safety stock policy data, inventory reduction target data, direct product costs, indirect product costs, and sales, general and administrative (SG&A) costs.

5. A method of evaluating an operational strategy of a manufacturing business, comprising the steps of:
establishing one or more parameters defining the operational strategy being evaluated;
inputting the one or more parameters defining the operational strategy into a simulator;
inputting financial data relating to the operational strategy into the simulator;
running the simulator so as to simulate the operational strategy for a first time frame, wherein the first time frame is defined by two or more sequential and equal units of time;
generating financial data relating to the operational strategy being evaluated;
modifying the one or more parameters defining the operational strategy being evaluated; and
rerunning the simulator so as to simulate the operational strategy for a second time frame.
